(19) United States
(12) Patent Application Publication
(10) Pub. No.: US 2023/0400672 A1
(43) Pub. Date: Dec. 14, 2023

(54) CATADIOPTRIC-OPTICAL ARRANGEMENT

(71) Applicant: Carl Zeiss AG, Oberkochen (DE)

(72) Inventors: Alexander Epple, Aalen (DE); David Shafer, Fairfield, CT (US); Johannes Stock, Ellwangen (DE)

(21) Appl. No.: 18/209,456

(22) Filed: Jun. 13, 2023

(30) Foreign Application Priority Data
Jun. 13, 2022 (DE) 10 2022 114 814.9

(51) Int. Cl. G02B 17/08; G02B 9/10; G02B 9/02

(52) U.S. Cl. CPC G02B 17/0856; G02B 9/10; G02B 9/02; G02B 21/02

(57) ABSTRACT

An optical arrangement is provided. The optical arrangement has a center axis, an object side, an image side, and a catadioptric arrangement. The optical arrangement has an installation space of no more than 25 millimeters from the object side to the image side along the center axis, and a linear obscuration of no more than 60 percent.

### CROSS REFERENCE TO RELATED APPLICATIONS

This application claims priority to German patent application DE 10 2022 114 814.9, filed Jun. 13, 2022, the entire content of which is incorporated herein by reference.

### TECHNICAL FIELD

The present disclosure relates to an optical arrangement, an objective, in particular for a microscope, a camera and/or a projector, an image capture apparatus, an image reproduction apparatus, and a device, in particular a mobile device.

### BACKGROUND

Document DE 2 157 058 A describes a mirror lens objective for imaging with a common object side and image side. This arrangement is referred to as “catadioptric” within that document. Deviating therefrom, a catadioptric arrangement in the context of the present disclosure is understood to mean an arrangement including a first mirror with converging refractive power and a subsequent mirror with diverging refractive power.

Modern cellular telephones usually have one or more integrated cameras, with which it is possible to record high-quality images or videos. These cameras are attached virtually exclusively to the front and back side of the mobile device, with the optical axis of the associated optics being aligned perpendicular to the said front and back side. As a consequence, the installation length of the optical system is specified by the thickness of the mobile device, for example of the cellular telephone. In this context, 6 mm to 8.5 mm are typical values.

An optical system whose focal length is comparable to the length of the installation space L, which is to say the thickness of the mobile device, can be realized in this installation space. The telephoto factor F=L/f specifying the ratio of the installation length L to the focal length f is more or less 1. Telephoto structures, which is to say systems with a focal length longer than the installation space or F°<° 1, or retrofocus structures, which is to say systems whose focal length is shorter than the installation length or F°>° 1, can only be realized with great difficulties. Thus, a solution for increasing the focal length of the optical unit is sought after, in order to fulfill user demands for improved objectives.

According to an aspect of the disclosure, close objects may be imaged with microscopic magnification using the aforementioned cameras. A large working distance must be realized in order to ensure good illumination. Moreover, the object should be imaged with an imaging scale close to 1:1. What follows from the two demands is that the installation length of the objective must be comparable with the front working distance, with the consequence that the conventional installation space is insufficient to this end. Thus, a concept for realizing a long focal length or installation length in a short installation space is sought after.

In particular, microscope objectives can be configured as mirror objectives (catadioptric objectives). In this respect, the related art is discussed for example in “Lexikon der Optik-Mikroskopobjektiv” https://www.spektrum.de/lexikon/optik/mikroskopobjektiv/2067, U.S. Ser. No. 10/877,244 B1, US 2019/0187446 A1, U.S. Pat. No. 6,169,637 B1 and U.S. Pat. No. 5,930,055 A. For example, the beam path can be folded along the optical axis with the aid of Cassegrain-, Gregory-, Schwarzschild-, or Maksutov-type catadioptric objectives. While the Schwarzschild system leads to significant obscuration, the Petzval sum is no longer corrected in Cassegrain- and Gregory-type astronomical telescopes. The aforementioned design structures are already used in conventional photography, especially in the case of long focal length objectives. In addition, these design types have already been transferred to cellular telephone applications. Examples to this end have been disclosed in the documents U.S. Pat. No. 10,877,244 B1 and US 2019/187446 A1.

In principle, a catadioptric group forms a powerful telephoto structure made of a first mirror with converging refractive power and a subsequent mirror with diverging refractive power. This refractive power sequence represents a catadioptric telephoto structure and thereby causes an installation length shortening of the objective in comparison with the nominal focal length. Moreover, the use of reflective components results in folding of the optical path in the direction of the optical axis, additionally leading to a shortening of the installation length. Overall, a catadioptric group may lead to very small telephoto factors F. The individual refractive powers of the mirror surfaces have to be adapted in order to reduce the obscuration of the catadioptric system. However, this leads to the basic catadioptric system alone no longer being corrected for all aberrations, with the result that there is the need for additional optical correction elements. These are aspherical lenses arranged downstream of the catadioptric group when viewed in the direction of light propagation, which is to say between the catadioptric group and the image plane, in the aforementioned documents.

To be able to design the optical system compactly, some of the correcting lens elements even reach into the mirror interspace, leading to challenges in terms of mounting. Moreover, both the front side and the back side of the catadioptric block lens have undesirable discontinuous edges in the aforementioned documents.

In the context of the further development of smartphones, what are known as “CMOS imaging sensors” (CISs) with ever smaller pixel dimensions and highly efficient, integrated image processing are becoming available. Microscopy could also profit therefrom in terms of the realization of compact and cost-effective systems. Image representations with a scale of almost 1:1 can be realized as a result, especially in the mid-resolution range of a few micrometers. For instance, if the pixel dimension is 1 μm (edge length), resolutions down to approximately 2 μm are realizable in the case of an imaging scale of 1:1 according to Nyquist's theorem. Naturally, reducing optics could achieve even higher resolutions.

If imaging is from an object space in air to an image space in air, 1:1 imaging has the additional peculiarity that it is possible to image not only a surface element but an entire volume element, in each case on one another, with a high imaging quality. In this case, an object space is understood to mean a spatial region in which at least one object plane or a plurality of object planes of the imaging optical unit are situated, and an image space is understood to mean a spatial region in which at least one image plane or a plurality of image planes of the imaging optical unit are situated. The aim is therefore to realize a volume image representation with simpler means.

Rotationally symmetric systems are considered hereinafter for the purpose of explaining the technological background. The further assumption is made that the spherical aberration of the optical system has been corrected. Then, the image point in the center of the image field can be imaged without aberrations. Further conditions must additionally be placed on the optical system if the aim is to also transfer a small area around the image center without aberrations. The usual case is that a lateral extent of the object is considered, which is to say the aim is to image a planar object perpendicular to the optical axis. For example, this is the case in photography. In this case, the Abbe sine condition must be corrected. It states that the sine of the angle of the marginal rays with the optical axis in the object plane and image plane must form a fixed ratio:

$$\frac{n \cdot sin ( u )}{{n}^{′} \cdot sin ( {u}^{′} )} = β = const .$$

Here, n is the refractive index of the respective medium, u is the angle included by the ray and the optical axis, and β is the imaging scale of the system. Dashed variables relate to the image space; variables without a dash relate to the object space. The ratio β must apply to all openings, which is to say in the case of all possible openings up to the maximum numerical aperture of the system.

An often less frequently considered case is where an axial extent of an object should be imaged along the optical axis. In that case, what is known as Herschel's condition must be satisfied; it can be formulated as follows:

$$\frac{n \cdot {sin}^{2} ( \frac{u}{2} )}{{n}^{′} \cdot {sin}^{2} ( \frac{{u}^{′}}{2} )} = α = const .$$

Abbe sine condition and Herschel condition are only simultaneously fulfillable if the following applies to the marginal ray angles in the object space and image space:

|u|=|u′|

From this, the following applies to the lateral scales p and the depth scales a in the nominal image plane:

$$\vert α \vert = \frac{n}{n ′} and \vert β \vert = \frac{n}{n ′}$$

If the object and image are in air, the following applies:

|α|=|β|=1

By contrast, if the object is in an aqueous solution (n≈1.334, n′=1), |α|=|β|≈1.334 applies.

Abbe sign condition and Herschel condition are therefore necessary preconditions for the object to be able to be imaged aberration-free in close surroundings next to, or in front of and behind, the central image point in the nominal object plane. Therefore, they are the precondition for volume imaging.

However, simultaneous fulfilment of Abbe sine condition and Herschel condition provides no information about the similarity of object and image, which is to say whether a cube-like object is also cube-like when imaged.

### SUMMARY

The following ideas provide fundamentals for a part of the present disclosure and simultaneously are constituents of the disclosure. To ensure the specified further condition, the chief ray angles in the object space and in the image space must still be matched to one another. Suppose the object and image are in air, and let 7 be the (geometric) chief ray angle at the object. Then |α|=1 is the depth scale. Thus, if the back focal length at the object is modified by a value of Δs₀=d₀, then the image plane must be refocused by a value of Δs₁=−d₀.

In general, the chief ray of the original image representation then intercepts the object plane at a different height. To ensure volume-faithful imaging, the chief ray in the image space must intersect the object plane at the same modified height. This is only possible if the sum of the chief ray angles upstream and downstream of the optical unit vanishes (γ+γ′=0). This relationship is illustrated in FIG. 1. In the case of a simple, symmetric 1:1-system, the nominal imaging is given by A₀->A₀′. If the front focal distance is altered and the Abbe sign condition and Herschel condition are satisfied, A₁->A₁′ is imaged with the same chief ray. It is self-evident, however, that the imaging no longer describes a 1:1 image representation. Cubes are imaged onto conical frustums.

However, if the chief ray angles in the object space and image space are suitably matched to one another, then the modified image representation is also a 1:1 image representation again. In the present, schematic case, this is possible for example by the targeted use of a field lens. In this case, volume imaging will lead to a 1:1 image representation again, which is to say cubes are imaged onto cubes.

This relationship likewise applies in the generalization of any desired media n, n′ in the object space and image space; the geometric angles of the chief rays in the object and in the image must complement one another to equal zero. In this case, the signed imaging scale can be included in the formula and the correct sign can be ensured as a result.

n·γ=β·n\hat{ }′·γ\hat{ }′

In other words, convergent chief rays at the object need to become convergent chief rays at the image, and vice versa. A special case is where both the object-side and the image-side chief ray angles vanish (γ=γ′=0). That case relates to a doubly telecentric optical unit. However, a doubly telecentric optical unit is disadvantageous in the mobile radio optics field of use since it would increase both the diameters of the optical parts and the installation length.

The documents Switz et al., Low-Cost Mobile Phone Microscopy with a Reversed Mobile Phone Camera Lens, Plos One, Volume 9, Issue 5, e95330 (May 2014) and Diederich et al., Using machine-learning to optimize phase contrast in a low-cost cell-phone microscope, Plos One, March 1 (2018) (https://journals.plos.org/plosone/article?id=10.1371/journal.pone.0192937) describe microscopic imaging, inter alia, by attaching a reversed cellular telephone objective in front of a smartphone camera. However, this is not a telecentric system. The symmetry results in convergent chief rays on the object side while divergent chief rays appear on the image side, with the result that the chief ray angle condition is not met; a cuboid volume is consequently imaged onto a pyramidal frustum volume. In Botcherby et al., Aberration-free optical refocusing in high numerical aperture microscopy, Optics letters, Vol 32, No 14, pg. 2007-2009 (2007), use is made of a structure made out of micro-objectives; it generates an intermediate image with a 1:1 magnification.

Optics for cellular telephone cameras virtually exclusively include pure lens systems which are integrated into the telephone in the smallest possible installation space. In the process, the entire system must be integrated within the thickness of the telephone, which is typically 5 mm or 6 mm. The obtainable focal length of a correspondingly short optical unit then is comparable to the installation length of the optical unit or even shorter, for example between 3 mm and 4 mm (see U.S. Pat. No. 7,643,225 B1 and McGuire Jr., James P., Manufacturable mobile phone optics: higher order aspheres are not always better, Proc.SPIE 7652, International Optical Design Conference 2010, 765210 (9 Sep. 2010), doi: 10.1117/12.871016). In terms of character, what consequently tend to arise together with a typical receiver size, for example with a diagonal of approximately 4 mm, are wide angle objectives with “equivalent focal lengths” of significantly below 50 mm. For landscape photography, this is desirable and accepted as such by users. The impression of recordings with a longer focal length is realized by digital zooming. Nevertheless, there is an increased desire for a cellular telephone or smartphone to have objectives with a truly longer focal length, for instance for the portrait photography or telephoto photography. This requires longer focal lengths, but these are not compatible with the compact installation space.

As already described above, it is also possible to efficiently use the installation space with centered optical units by folding the beam path along the optical axis. However, this has a pupil obscuration as a consequence, which is to say the central part of the optical pupil receives no light.

The obscuration is typically specified by the diameter ratio of the diameter of the shading to the diameter of the object pupil. FIG. 2 illustrates how the obscuration should be calculated. Initially, imaging of the field center by an open beam 17 is considered. There is a light ray R₁ which on its course through the optical system grazes subsequent surfaces; in the case of FIG. 2, this is the second optical surface 32 (secondary mirror) which has an obscuring effect in the incident light beam. Rays with a smaller value of the system aperture, which is to say rays running between the optical axis 2 and the ray R₁ under consideration, are consequently blocked by the subsequent surfaces. Rays with a larger value of the system aperture, up to the marginal ray R₀, will be able to pass through the system unimpeded, which is to say they are reflected by a radially outer region of the surface 31 (primary mirror) to the secondary mirror 32 and pass through the radially inner region of the surface 31 or primary mirror following a reflection at the surface 31. The obscuration therefore corresponds to the ratio of the entrance pupil coordinates of the ray R₁ and the ray R₀. In the case of a collimated light input beam (telescopic imaging), this is the height ratio of R₁ and R₀ in the entrance pupil, which is to say the ratio of the heights h₁ and h₀ in FIG. 2.

In the case of a finite light input (projection objective), this is the ratio of the direction cosines rvl₀ of the ray R₁ and rvl₁ of the ray R₀. In this case, the direction cosine rvl₀ of the ray R₀ just specifies the numerical aperture of the object space. It is desirable to keep the obscuration as small as possible. The reasons set forth hereinafter are decisive in this respect. The larger the obscuration, the more light is shadowed, which leads to the necessity of longer exposure times. This effect depends quadratically on the obscuration. The larger the obscuration, the less image contrast there is in particular for long-wavelength structures; thus, there is a reduction in the associated image contrast, which is characterized by way of the modulation transfer function MTF. This effect depends linearly on the obscuration. Furthermore, the obscuration can become unpleasantly noticeable as “donuts” in the bokeh, which is to say the focused images of highlights.

For example, catadioptric photographic objectives have been disclosed in documents U.S. Pat. No. 4,714,307 B1 and U.S. Pat. No. 6,169,637 B1. However, significant obscurations occur in these cases. Naturally, large values for the obscuration also occur in the case of multiple reflections in lens bodies (see U.S. Pat. No. 5,930,055 B1, for example).

Against this background, it is an object of the present disclosure to provide an advantageous optical arrangement. Further objects consist in making available an advantageous objective, an advantageous image capture apparatus, an advantageous image reproduction apparatus, and an advantageous mobile device. These objects are achieved by an optical arrangement, an objective, an image capture apparatus, an image reproduction apparatus, and a device as described herein.

The optical arrangement according to an aspect of the disclosure includes a center axis (which may coincide with the optical axis), an object side, an image side, and a catadioptric arrangement, wherein the catadioptric arrangement includes a first mirror with converging refractive power and a subsequent mirror with diverging refractive power. Along the center axis, the optical arrangement has an installation space or an overall length L from the object side to the image side of no more than 25 millimeters (25 mm), typically of no more than 10 millimeters (10 mm). The optical arrangement moreover has a linear obscuration of no more than 60 percent.

For the applications as a photographic objective (with a collimated input), the focal length can typically be between 15 mm and 30 mm, for example 20 mm or approximately 20 mm. For applications in mobile devices, for example smartphones, the installation space or the overall length may be no more than 9 mm, advantageously no more than 6.5 mm. In the case of the microscope structure, which is to say an application as a microscope, the distance between object and optical unit (working distance FWD) may be at least 15 mm.

The optical arrangement according to an aspect of the disclosure is advantageous in that it enables high-quality microscopic imaging with little obscuration in a small installation space.

In a first variant, the catadioptric arrangement includes a first, partly reflective optical component with a front side arranged on the object side and a back side arranged on the image side, and a second, partly reflective optical component with a front side arranged on the object side and a back side arranged on the image side, the said optical components being arranged in succession, in particular one behind the other, in the beam path along the center axis so that the first optical component is arranged on the image side of the second optical component. The first optical component, typically the back side of the first optical component, includes a radially inner region and a radially outer region in relation to the center axis, the inner region being configured to be at least partly transparent to, or to at least partly transmit, light incident from the object side and the back side of the outer region being configured to reflect light incident from the object side. The second optical component includes a radially inner region and a radially outer region in relation to the center axis, the outer region being configured to transmit, or be transparent to, light incident from the object side and the inner region being configured to reflect light incident from the image side. In this case, the front side or the back side of the second optical component may have a reflective surface region. Furthermore, at least one first refractive surface with refractive power, which is to say having refractive power, and one second refractive surface with refractive power, which is to say having refractive power, are arranged in the beam path between the back side of the first optical component and the front side of the second optical component in the present variant.

For example, the front side of the first optical component and the front side and/or the back side of the second optical component can be configured to be transparent. The respective reflectively configured regions can be configured to be circular or ring-shaped. The partly reflective region of the first optical component can have a concave form on the object side. The partly reflective region of the second optical component can have a convex form on the image side.

The described first variant of the present disclosure is advantageous in that it requires no further optical elements, which is to say no optical elements through which light passes once, with refractive power in the beam path downstream of the catadioptric arrangement. In this context, plane parallel plates, for example a protective window in front of an image receiver, are not understood to be elements with refractive power. The surfaces with refractive power arranged between the first optical component and the second optical component or formed by the facing surfaces of the first optical component and the second optical component enable an installation space-saving efficient correction of aberrations. Furthermore, the described configuration has a significantly simpler configuration in comparison with the prior art from a mounting technology point of view, which is why the production costs can be reduced at the same time.

In an exemplary embodiment of the disclosure, the first refractive surface with refractive power can be formed by the front side of the first optical component and/or the second refractive surface with refractive power can be formed by the back side of the second optical component. The aforementioned surfaces can be configured as aspheres or free-form surfaces and consequently be designed for the targeted correction of imaging aberrations. An asphere is understood to mean a lens element with a rotationally symmetric surface, the surface of which may have surface regions with radii of curvature that deviate from one another.

The first optical component can be configured such that only the front side and/or only the back side has refractive power, which is to say be made with refractive power, and the image plane is arranged immediately on the image side of the first optical component, which is to say without a further optically effective surface, through which light passes once in the beam path, in particular without a refractive or diffractive surface. In other words, the optical arrangement can be designed for the arrangement of an image receiver or an image capture apparatus in the beam path immediately downstream of the back side of the first optical component.

Optionally, at least one third optical component may be arranged geometrically, and in the beam path, between the first optical component and the second optical component. The at least one third optical component typically has a refractive configuration. The at least one third optical component can be designed to correct at least one imaging aberration. This further improves the imaging quality.

Advantageously, especially of advantage from a mounting technology point of view, the radial extents of the individual optical components, which is to say of the first and/or second and/or third optical component, of the optical arrangement deviate from one another by no more than 2 millimeters or no more than 30 percent.

The outer region and the inner region of the back side of the first optical component can have different surface shapes from one another. Additionally or in an alternative, the outer region and the inner region of the front side and/or back side of the second optical component can have different surface shapes from one another. This offers advantages in relation to further degrees of freedom for collecting operations. The outer or inner region of the back side or front side is specified in this case by the above-described inner or outer regions of the respective component.

The aforementioned optical components may be configured to be rotationally symmetrical with respect to the center axis. An air lens, which is to say an air-filled distance, may be arranged between at least two of the aforementioned optical components. The entrance pupil may have an extent of between 7 mm and 9 mm, for example 8 mm. At least one of the aforementioned optical components may have at least one aspherical surface or a free-form surface. At least two of the optical components may consist of the same material, allowing manufacturing costs to be reduced. At least one region configured to be reflective can be configured as a converging Mangin mirror.

In a second variant of the present disclosure, at least one field lens, for example a refractive field lens, is arranged in the beam path and/or geometrically between the catadioptric arrangement and the image side, which is to say between the back side of the first optical component and the image plane. In the present context, a field lens is understood to mean a lens arranged at a point within the optical beam path where the chief ray height of the imaging is larger than or equal to the marginal ray height. In particular, a field lens group can be arranged in the beam path and/or geometrically between the catadioptric arrangement and the image side. The at least one field lens can be configured as a converging lens, which is to say a lens with positive refractive power, and/or as a diverging lens, which is to say a lens with negative refractive power. For example, only one converging lens or only one diverging lens may be present as a field lens. This facilitates a simple and compact structure of the optical arrangement and allows the realization of a convergent chief ray for the purpose of realizing correct volume imaging. In the case of a field lens group, the latter may include at least one converging lens and/or at least one diverging lens.

By way of example, at least one field lens group, for example at least one refractive field lens group, including at least one lens or lens group with positive refractive power and/or at least one lens or lens group with negative refractive power may be arranged in the beam path and/or geometrically between the catadioptric arrangement and the image side of the optical arrangement, which is to say between the back side of the first optical component and the image plane. This results in numerous degrees of freedom for correcting aberrations and for improving the quality of an image representation, in particular a microscopic image representation. Advantageously, the field lens group includes a first lens or lens group with positive refractive power and a second lens or lens group with negative refractive power arranged upstream of the first lens or lens group, which is to say on the object side thereof, in the beam path. This allows the conditions for volume imaging to be realized, in particular a position of the exit pupil downstream of the image plane with a strong positive refractive power near the image and downstream of a very divergent chief ray. In particular, the absolute value of the geometric chief ray angle with respect to the optical axis or the center axis may be substantially the same in the object space and in the image space. In this context, the absolute values of the chief ray angle in the object space and in the image space may differ by no more than 5 degrees.

As a further option the catadioptric arrangement may include a front side arranged on the object side, a back side arranged on the image side and, in relation to the center axis, a radially inner region and a radially outer region, with the inner region on the back side being configured to at least partly transmit, or to be at least partly transparent to, light incident on the object side and having negative refractive power. This is advantageous in that the inner region of the back side can be configured as a lens and act as such, and this allows corresponding functions of a field lens to be integrated into the catadioptric arrangement, which in turn has an installation space-reducing effect.

For example, the catadioptric arrangement may include a first, partly reflective optical component with a front side arranged on the object side and a back side arranged on the image side, and a second, partly reflective optical component with a front side arranged on the object side and a back side arranged on the image side, the said optical components being arranged in succession, in particular one behind the other, in the beam path along the center axis such that the first optical component is arranged on the image side of the second optical component. In this case, the first optical component, for example the back side of the first optical component, may include a radially inner region and a radially outer region in relation to the center axis, the inner region being configured to be at least partly transparent to, or to at least partly transmit, light incident from the object side and the back side of the outer region being configured to reflect light incident from the object side. In this case, the second optical component, for example the front side or the back side, includes a radially inner region and a radially outer region in relation to the center axis, the outer region being configured to transmit, or be transparent to, light incident from the object side and the inner region being configured to reflect light incident from the image side. In this case, the front side or the back side or a surface in the interior of the component may have a reflective embodiment. Advantageously, the radially inner region of the first optical component has negative refractive power. This is advantageous for the reasons specified in the paragraph above.

The optical arrangement is typically configured not to be symmetrical with respect to a plane arranged perpendicular to the center axis. In comparison with symmetric arrangements, a non-symmetric arrangement offers advantages in the context of the realization within as little installation space as possible. In a further configuration, typically, inter alia, on account of installation space efficiencies, the optical arrangement does not generate a real intermediate image or generates an even number of intermediate images between the object side and the image side (or between an object plane and an image plane). This can generate a negative imaging scale.

In a third variant of the present disclosure, a field lens group, typically a refractive field lens group, is arranged on the image side of the catadioptric arrangement. The optical arrangement defines an image plane. Moreover, the optical arrangement has an installation length Lₛ measured from the vertex of the first optical surface, for example of the front side of the catadioptric arrangement or second optical component, to the image plane and the field lens group has a paraxial focal length f′_{FL} less than zero (f′_{FL}<0), wherein the absolute value of the paraxial focal length f′_{FL} is less than the installation length Lₛ(|f′_{FL}|<Lₛ). A particular advantage of the third variant is that there is a significant reduction in the obscuration.

The cause for the obscuration is due in principle to the fact that a convex secondary mirror is generally arranged geometrically in front of a concave main mirror of a catadioptric arrangement and therefore shadows the latter. As already explained above, a first rough estimate for the value of the obscuration can therefore be found in the ratio of the external diameters of the two reflective surfaces. This estimate would specify the true obscuration if there were no further optical element between the two mirrors or reflectively configured regions and if the field angle were to tend to zero.

An optical unit between the mirrors can have an advantageous influence on the obscuration. A finite field angle increases the obscuration. Two points are decisive for the specific design of the obscuration. At the secondary mirror geometrically close to the object, the light beam entering into the optical arrangement is curtailed by the contour of the secondary mirror, predominantly of the reflectively configured inner region of the second optical component. At the primary mirror geometrically close to the image, predominantly at the reflectively configured outer region of the first optical component, the reflected light beam is curtailed by the central or radially inner region, which serves to guide the light reflected by the secondary mirror to the outside.

To keep the obscuration as small as possible, the diameter of the secondary mirror should be minimal and the diameter of the transmissively configured inner region of the primary mirror should be minimal. The second condition shall be considered first; this is illustrated schematically in FIG. 3. Imagine a reversed beam path from the objective and trace the light rays backward through the optical system from the detector. If hypothetically a telecentrically illuminated detector were present (see FIG. 3, top left), the beam diameter do upstream of the detector or the image plane 6 grows significantly with distance. If the primary mirror were at a distance L₀ upstream of the image plane 6, then its central bore or the radially inner region would need to have at least the size of the detector diagonal plus the diameter of the light beams increased as a result of beam divergence.

If there is deviation from telecentricity at the detector to the effect that the chief rays at the detector diverge from the optical axis (see FIG. 3, bottom left), which is to say the exit pupil is located closely upstream of the image plane 6, then the beam diameter d₁ level with the central bore or radially inner region of the first mirror (once again assumed at a distance L₀ in front of the detector) can be designed to be significantly smaller. However, the catadioptric structure causes the system pupil to be located within the catadioptric part of the system. Therefore, despite advantageously pronouncedly non-telecentric conditions at the image, the pupil position must be kept away from the image plane. The solution in this respect lies in the use of a field lens group with a strongly negative refractive power, as shown schematically in FIG. 3, right. In this context, a field lens is understood to be a lens arranged in the vicinity of a detector and for example characterized in that the chief ray height is larger than the marginal ray height.

As a result of using field lenses with negative refractive power, the diameter of the light beam level with the central opening or radially inner region of the first mirror is minimal, which is conducive to the obscuration of the overall system. However, it is necessary to note that the strong negative refractive power in the vicinity of the image plane supplies a large over-correcting contribution to the Petzval sum of the system. The converging mirror required for the imaging likewise supplies an over-correcting contribution to the Petzval sum. The only element supplying a significant and over-correcting contribution to the Petzval sum is the convex secondary mirror. To arrive at a balanced Petzval sum, the curvature of the secondary mirror must therefore increase. This in turn leads to the marginal ray height at the location of the secondary mirror having to become smaller so that the effects of the latter's increased curvature on the overall refractive power of the system are not allowed to become too large. The overall refractive power of the optical system or optical arrangement is given by the sum over the product of the refractive powers of the individual surfaces and the relative marginal ray height. In this context, the relative marginal ray height is understood to be the quotient of marginal ray height and entrance pupil radius. Thus, the aforementioned conditions lead to a reduction of the secondary mirror and to a reduction of the obscuration. In summary, the use of significant negative refractive power in the field lens group between the catadioptric arrangement and an image plane or the image side of the optical arrangement is conducive for the reduction in the obscuration. Typically, the absolute value of the paraxial focal length f′_{FL} is less than the installation length Lₛ(|f′_{FL}|<Lₛ).

To specify this refractive power mathematically, it is possible to resort either to conventional, paraxial refractive power or to a refractive power based on best fit radii. The conventional refractive power

$${ϕ}^{′} = \frac{1}{{f}^{′}}$$

of a thin lens in air is given by the vertex radii r₁, r₂ of a lens and the refractive index or index of refraction n of the lens medium, as

$${ϕ}^{′} = ( n - 1 ) ( \frac{1}{{r}_{1}} - \frac{1}{{r}_{2}} )$$

Here, f′ is the image-side focal length of the lens. Very aspherical optical elements are used in the field of cellular telephone optics, with the result that a paraxial refractive power often has only very limited significance in relation to the true effect of the optical element. The practice of making the surfaces so aspherical that optical elements in the radially inner region have a different sign of the refractive power than in the radially outer region is conventional. For example, they may be designed as converging in the vicinity of the optical axis or center axis, which is to say in the radially inner region, but have a diverging design in the edge region or radially outer region. Thus, to express the demand for a diverging effect on the chief rays in the edge region or radially outer region of the field lenses, the aim is to define a best fit radius refractive power. This is based on the best fit radii of the surfaces bounding the respective surfaces.

Let p be the sag of a lens surface measured at the maximally optically clear height h_{MAX} of the lens, which is to say perpendicular to the center axis of the lens. Then, it is possible to determine a circle which intersects the lens surface both at the vertex and at the height h_{MAX}. The radius of this circle is

$${r}_{bf} = \frac{{h}_{Max}^{2} + {p}^{2}}{2 p}$$

r_{bf} is now defined as the best fit radius. Now, it is possible to define the best fit radius refractive power φₕᵣ′ in a manner analogous to the paraxial refractive power:

$${φ}_{h r}^{′} = ( n - 1 ) ( \frac{1}{{r}_{hf , 1}} - \frac{1}{{r}_{hf , 2}} )$$

Here, r_{hr,1} and r_{hr,2} are the respective best fit radii of the front side and back side.

At least one field lens, for example a field lens group, typically with a refractive configuration, can be arranged on the image side of the catadioptric arrangement, and the optical arrangement can define an image plane. The optical arrangement may have a clear optical diameter D₂ on the image side of the back side of the catadioptric arrangement, in particular the back side of the first optical component of the catadioptric arrangement. In this case, the clear optical diameter is understood to mean the maximum beam height (i.e., distance from the optical axis or center axis) of a light ray imaged on this surface. An image plane defined by the optical arrangement may have an imaging surface with a diameter D₁. In this context, the imaging surface defines the region of the image plane in which an image representation can be produced by the optical arrangement. The optical arrangement may also have an image receiver with a diameter D₁. In this case, the ratio of the clear optical diameter D₂ to the diameter D₁ of the imaging surface or image receiver is less than 1 (D₂/D₁<1). Thus, the beam path is expanded by the field lens or field lens group, and hence the obscuration is reduced.

Further, at least one field lens, for example a field lens group, which typically has a refractive configuration, can be arranged on the image side of the catadioptric arrangement, and the optical arrangement can define an image plane, wherein the optical arrangement has a focal length f and an installation length Lₛ measured from the vertex of the first optical surface, for example the front side of the catadioptric arrangement or of the second optical component, to the image plane and the ratio of the focal length f to the installation length Lₛ is larger than 2 (f′/Lₛ>2). As a result, microscopic imaging with optical units designed for mobile devices, for example cellular phones, is rendered realizable.

Moreover, at least one field lens, for example a field lens group, typically with a refractive configuration, can be arranged on the image side of the catadioptric arrangement, and the optical arrangement can define an image plane. In this case, the optical arrangement has an imaging scale β, a distance FWD from an object plane, in particular an object surface, to the vertex of the first optical surface, for example the front side of the catadioptric arrangement or the front side of the second optical component, as measured along the center axis of the optical arrangement, and an installation length Lₛ, as measured from the vertex of the first optical surface to the image plane. In this case, the product of the imaging scale β and the quotient of the distance FWD and the installation length Lₛ is larger than 2.

$$\frac{F W D}{Ls} β > 2$$

This configuration also allows microscopic imaging in the case of only very little available installation space for an appropriate optical unit.

Optionally, the chief ray angle of the beam path may have a direction cosine rvl₂ immediately prior to leaving the catadioptric arrangement at the back side of the latter, where the catadioptric arrangement has a refractive index n₂, and the chief ray angle of the beam path may have a direction cosine rvl₁ in an image plane within an image-side medium with a refractive index n₁, for example at a detector, wherein the following applies:

$$\frac{{n}_{2} {rvl}_{2}}{{n}_{1} {rvl}_{1}} < 1$$

This configuration effectively reduces the obscuration.

The geometric angle of the chief ray with the optical axis may have a first absolute value in the object space and the geometric angle of the chief ray with the optical axis may have a second absolute value in the image space, the said second absolute value differing from the first absolute value by less than 1 degree. Volume-faithful imaging with reduced obscuration can be realized as a result.

In all above-described variants, the arrangement can have a negative imaging scale and/or a positive entrance pupil position and/or a positive exit pupil position. Near the edge, the front side of the second optical component may have a concave shape. The negative imaging scale has, as a consequence, and as an advantage, that no intermediate image is generated. The entrance pupil position is typically close to 0 since the system stop is located either on the first surface, or no later than on the “first optical element”. The positive position of the exit pupil arises if the chief rays intersect the optical axis downstream of the image plane, which, according to an aspect of the disclosure, is the goal.

The beam path may have an even number of reflections. To efficiently reduce the installation space, the optical arrangement may be constructed symmetrically in relation to no plane perpendicular to the center axis. Thus, the structure is non-symmetrical in this respect.

The optical arrangement may have an aperture stop and the geometric distance between an object plane defined by the optical arrangement and the aperture stop is typically larger than the distance between the aperture stop and an image plane defined by the optical arrangement.

It is typical for at least one optical or optically effective surface, advantageously two or more or all, or all apart from one or all apart from two of the optical or optically effective surfaces in the beam path, to be configured to be continuous and at least once continuously differentiable. In particular, the respective surface may have a uniform polynomial surface description over the entire surface. This is especially advantageous from a manufacturing point of view, but also offers a sufficient number of degrees of freedom for reducing aberrations.

The optical arrangement advantageously has a linear obscuration of less than 50 percent, for example less than 40 percent. For example, the obscuration can be between 30 percent and 50 percent.

The optical arrangement according to an aspect of the disclosure can be configured as a microscope, in particular with an imaging scale of between 2 and 0.25 (2>|β′|>0.25). The optical arrangement according to an aspect of the disclosure can be designed for example for a mobile device (smartphone, notebook, netbook, tablet, smartwatch, etc.).

At least one optical component of the optical arrangement according to an aspect of the disclosure may have at least one aspherical surface or a free-form surface. Furthermore, only one optical component of the optical arrangement may consist of a flint-like material. However, at least two optical components of the optical arrangement may also consist of the same material or of mutually deviating material (e.g., crown material or flint material). At least one region configured to be reflective can be configured as a converging Mangin mirror.

An objective according to an aspect of the disclosure includes an above-described optical arrangement. The objective has the features and advantages already specified above in conjunction with the optical arrangement according to an aspect of the disclosure. The objective can be configured as a photographic objective for imaging distant objects or as a microscope objective.

The image capture apparatus according to an aspect of the disclosure, for example a camera or a microscope, and the image reproduction apparatus according to an aspect of the disclosure, for example a projector, include an objective according to an aspect of the disclosure.

The device according to an aspect of the disclosure, which may be a microscope or mobile device, includes an image capture apparatus according to an aspect of the disclosure or an image reproduction apparatus according to an aspect of the disclosure or an optical arrangement according to an aspect of the disclosure. The mobile device according to an aspect of the disclosure can be a cellular telephone, tablet, notebook, smartwatch, netbook, etc. The mobile device has the described advantages of the optical arrangement according to an aspect of the disclosure.

### BRIEF DESCRIPTION OF THE DRAWINGS

The disclosure will now be described with reference to the drawings wherein:

FIG. 1 schematically shows the beam path for generating a volume-faithful image representation.

FIG. 2 schematically shows the beam path through a catadioptric arrangement for the purpose of illustrating the obscuration.

FIG. 3 schematically shows options for reducing the obscuration.

FIG. 4 schematically shows an optical arrangement according to a first exemplary embodiment of the disclosure.

FIG. 5 schematically shows an optical arrangement according to a second exemplary embodiment of the disclosure.

FIG. 6 schematically shows an optical arrangement according to a third exemplary embodiment of the disclosure.

FIG. 7 schematically shows an optical arrangement according to a fourth exemplary embodiment of the disclosure.

FIG. 8 schematically shows an optical arrangement according to a fifth exemplary embodiment of the disclosure.

FIG. 9 schematically shows an optical arrangement according to a sixth exemplary embodiment of the disclosure.

FIG. 10 schematically shows an optical arrangement according to a seventh exemplary embodiment of the disclosure.

FIG. 11 schematically shows an optical arrangement according to an eighth exemplary embodiment of the disclosure.

FIG. 12 schematically shows an optical arrangement according to a nineth exemplary embodiment of the disclosure.

FIG. 13 schematically shows an optical arrangement according to a tenth exemplary embodiment of the disclosure.

FIG. 14 schematically shows an optical arrangement according to an eleventh exemplary embodiment of the disclosure.

FIG. 15 schematically shows an optical arrangement according to a twelfth exemplary embodiment of the disclosure.

FIG. 16 schematically shows an optical arrangement according to a thirtheenth exemplary embodiment of the disclosure.

FIG. 17 schematically shows an optical arrangement according to a fourteenth exemplary embodiment of the disclosure.

FIG. 18 schematically shows an optical arrangement according to a fifteenth exemplary embodiment of the disclosure.

FIG. 19 schematically shows a device according to an exemplary embodiment of the disclosure.

### DESCRIPTION OF EXEMPLARY EMBODIMENTS

The disclosure is explained in larger detail below on the basis of exemplary embodiments and with reference to the accompanying figures. Although the disclosure is more specifically illustrated and described in detail with the preferred exemplary embodiments, nevertheless the disclosure is not restricted by the examples disclosed and other variations can be derived therefrom by a person skilled in the art, without departing from the scope of protection of the disclosure.

The figures are not necessarily accurate in every detail and to scale, and can be presented in enlarged or reduced form for the purpose of better clarity. For this reason, functional details disclosed here should not be understood to be limiting, but merely to be an illustrative basis that gives guidance to a person skilled in this technical field for using the present disclosure in various ways.

The expression “and/or” used here, when it is used in a series of two or more elements, means that any of the elements listed can be used alone, or any combination of two or more of the elements listed can be used. For example, if a structure is described as containing the components A, B and/or C, the structure can contain A alone; B alone; C alone; A and B in combination; A and C in combination; B and C in combination; or A, B, and C in combination.

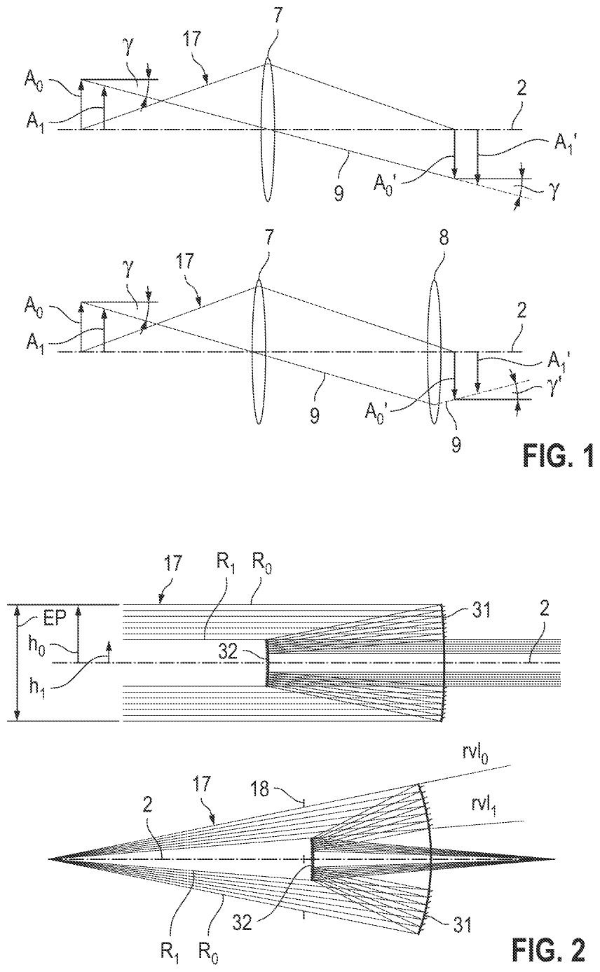

FIG. 1 schematically shows the beam path 17 for generating a volume-faithful image representation and has already been described in the introductory part of the description. A first converging lens 7 generates image representations A₀′ and A₁′ of objects A₀ and A₁, but, as shown at the top of FIG. 1, these image representations do not correspond in terms of their size relationships to the objects. At the bottom of FIG. 1, a further field lens in the form of a second converging lens 8 is used to adjust the direction of the chief ray 9 so that the size relationship of the generated image representations A₀′ and A₁′ corresponds to the size relationship the objects A₀ and A₁ have with respect to one another. The center axis of the lenses 7 and 8, which coincides with the optical axis, is identified by the reference sign 2.

FIG. 2 schematically shows the beam path through a catadioptric arrangement including a first optical surface 31 (primary mirror), which is reflective in a radially outer region, and a second reflective optical surface 32 (secondary mirror), and illustrates the calculation of the obscuration already described above. The entrance pupil or stop is identified by the reference sign 18. Light radiated in from the left in the FIG. is initially reflected by the first reflective optical surface 31, with some of the light being shadowed by the second reflective optical surface 32. Subsequently, the light reflected by the first reflective optical surface 31 is reflected by the second reflective optical surface 32 and passes the first optical surface 31 in a radially inner region. FIG. 2, bottom identifies the direction cosine of the marginal ray R₀ by an arrow rvl₀ and the direction cosine of the light ray R₁ by an arrow rvl₁.

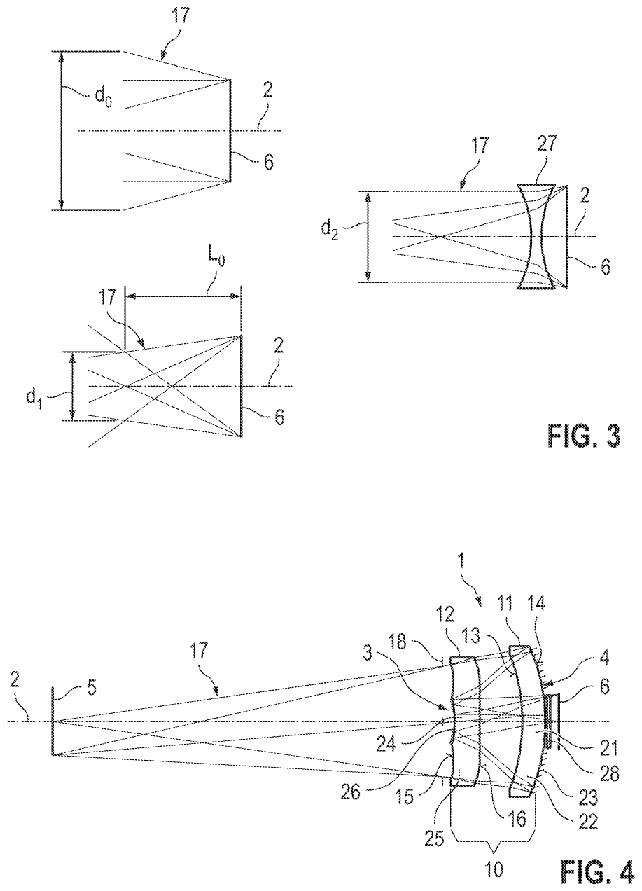

FIG. 3, which has already been described above, illustrates options for reducing the obscuration. In this case, the image plane or a detector is identified by reference sign 6 and a diverging lens for expanding the beam path 17 is identified by reference sign 27.

A first exemplary embodiment variant of the present disclosure is explained in more detail hereinafter on the basis of the exemplary embodiments shown schematically in FIG. 4 to 9. The optical arrangement 1 shown includes a center axis 2, which coincides with the optical axis in the examples shown, an object side 3, and an image side 4. In this case, the object inside 3 faces an object to be imaged or an object plane 5 and the image side 4 faces an image plane 6 or a detector, for example a camera, arranged in the region of the image plane. Moreover, the optical arrangement 1 includes a catadioptric arrangement 10.

The catadioptric arrangement 10 includes a first, partly reflective optical component 11 and a second, partly reflective optical component 12. These are configured as lenses in the example shown. The first, partly reflective optical component 11 includes a front side 13 and a back side 14. The second, partly reflective optical component 12 likewise includes a front side 15 and a back side 16. In this case, the front sides 13 and 15 face the object side 3 and the back sides 14 and 16 face the image side 4. The first optical component 11 and the second optical component 12 are arranged in succession in the beam path 17 along the center axis 2 such that the first optical component 11 is arranged on the image side of the second optical component 12.

In relation to the center axis 2, the first optical component 11 includes a radially inner region 21 and a radially outer region 22. In this case, the inner region 21 is configured to be at least partly transparent to, or at least partly transmit, light incident from the object side. The outer region 22 is configured to reflect light incident from the object side. To this end, the back side 14 of the first optical component 11 has a reflective coating 23. The latter is configured to be concave on the object side (convex on the image side) in the example shown.

In relation to the center axis 2, the second optical component 12 includes a radially inner region 24 and a radially outer region 25. In this case, the outer region 25 is configured to be transparent or transmissive to light incident from the object side. The inner region 24 is configured to be at least partly transparent to, or at least partly transmit, light incident from the object side and configured to reflect light incident from the image side. To this end, the front side 15 of the second optical component 12 has a reflective coating 26. The latter is configured to be convex on the image side (concave on the object side) in the example shown.

A plane parallel plate 28 is arranged between the back side 14 of the first optical component 11 and the image plane 6. This plane parallel plate may be a transparent cover.

The present exemplary embodiment is a microscope objective with an imaging scale of −1:0.8, which has a very large working distance of 28 mm in the case of an overall installation length of 8.5 mm. The system has a front stop, which is to say the system stop 18 is located in front of the actual optical system. The stop 18 may also be located within the optical arrangement 1. What is decisive for the stop position is that, when necessary, a diameter-variable stop can easily be realized from a mechanical point of view. For example, the stop 18 may also be located between the two optical components 11 and 12.

The shown optical components 11 and 12 may be configured to be rotationally symmetric, for example. In the example shown, the light enters into the optical arrangement 1 through a very large entrance pupil with virtually 8 mm diameter and is refracted by the front side 15 and the back side 16 of the second optical component 12 in its radially outer region 25. The front side 15 and the back side 16 of the second optical component 12 and the front side 13 of the first optical component 11 may have an aspherical embodiment. The reflective coating 23 of the first optical component 11 acts like a converging Mangin mirror for the incident light and it reflects the light back to the second optical component 12. The reflective coating 26 of the second optical component 12 acts like a diverging Mangin mirror for the incident light and it reflects the light back to the first optical component 11. Finally, the light once again passes through the first optical component 11 in the region near the axis, where this first optical component acts in the inner region 21 as a transmissive lens. No further optical elements with refractive power are passed after this point, and the light is incident in the image plane 6.

The front side 15 of the second optical component 12 has a different surface shape at the transition between the outer region 25 and the inner region 24, which is to say between the transmissive and the reflective region, than in the aforementioned regions. Although the transition is continuous, it is not differentiable, which is to say it has a kink. From a mounting technological point of view, the kink may be mechanically rounded-off by way of a chamfer. Moreover, it may also be embodied in discontinuous fashion.

The optical arrangement 1 shown in FIG. 4 has a linear obscuration of 40%. Linear obscuration means that, in the entrance pupil, the interior 40% of the entrance pupil coordinates cannot pass through the optical arrangement or will not be imaged. This is tantamount to an obscuration of 16% of the area of the entrance pupil (=40%² or 0.4²).

Obscuration decisively occurs during the light entrance into the optical arrangement 1 at the front side 15 of the second optical component 12. Here, the rays in the inner region of the pupil 18 are blocked at the central reflective coating 26. A further obscuration may occur during the reflection at the back side 14 of the first optical component 11, specifically if entering light rays pass through the non-reflective central region, which is to say the inner region 21, and are not reflected back to the second optical component 12.

The front side 13 of the first optical component 11 and/or the back side 16 of the second optical component 12 are designed to correct aberrations. In particular, they may be designed as spherical or aspherical surfaces or free-form surfaces. In the example shown, all surfaces and surface regions shown of the first optical component 11 and second optical component 12 have an aspherical configuration.

In principle, the first optical component 11 and the second optical component 12 may consist of different optical materials. In the example shown, the second optical component 12 has a refractive index of 1.493 and an Abbe number of 51.3 and acts as a crown material in this case. The first optical component 11 has a refractive index of 1.589 and an Abbe number of 26.2 and acts as a flint material in this case.

The first optical component 11 and the second optical component 12 have comparable diameters. The diameters may be identical or deviate from one another by no more than 30 percent.

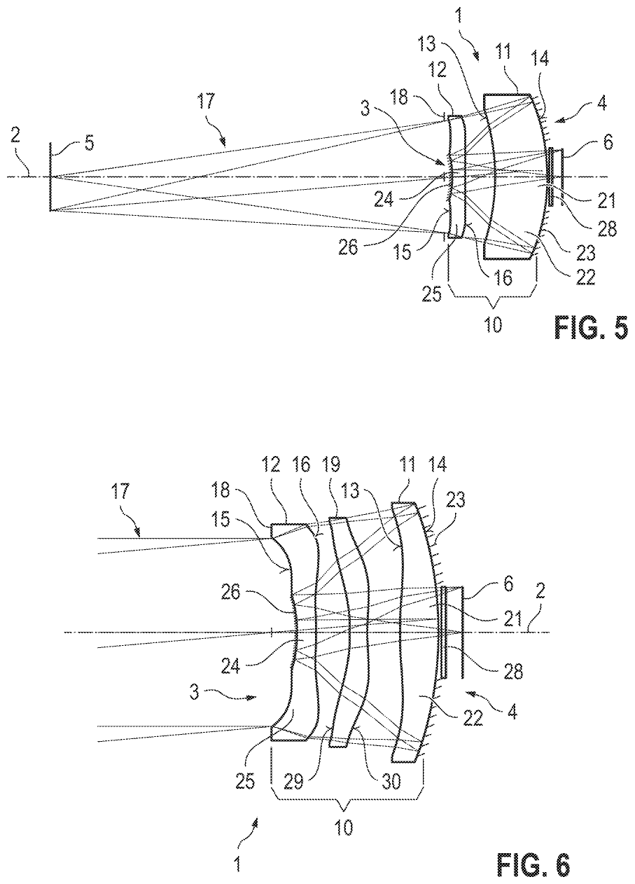

The exemplary embodiment shown in FIG. 5 is very similar to the exemplary embodiment shown in FIG. 4. The essential difference is that the use of a second optical material was dispensed with in this case. The first optical component 11 and the second optical component 12 are made of crown-type material. In other words, this relates to a one-material system. Alternatively, the first optical component 11 and the second optical component 12 may be made of flint-type material or may include such material.

The exemplary embodiment shown in FIG. 6 shows the design principle described in the preceding exemplary embodiments for a conventional photographic objective, which is to say for imaging from an infinite object distance to an image receiver. This is an optical arrangement 1 configured as an objective, having a focal length of f′=22 mm in the case of an installation space of only Lₛ=8,5 m, as measured along the center axis 2. Purely from a mathematical point of view, the telephoto factor is therefore F=0.39. Once again, this relates to a one-material system. In this example, the obscuration of the optical arrangement 1 is 40 percent.

The optical arrangement 1 moreover includes a third optical component 19 arranged geometrically or spatially, and in the beam path 17, between the first optical component 11 and the second optical component 12. In the beam path 17, light passes through the third optical component 19, which is configured as a refractive lens, three times. It has a front side 29 and a back side 30. The front side 29 and the back side 30 of the third optical component 19 can be embodied to be spherical or aspherical, or as a free-form surface.

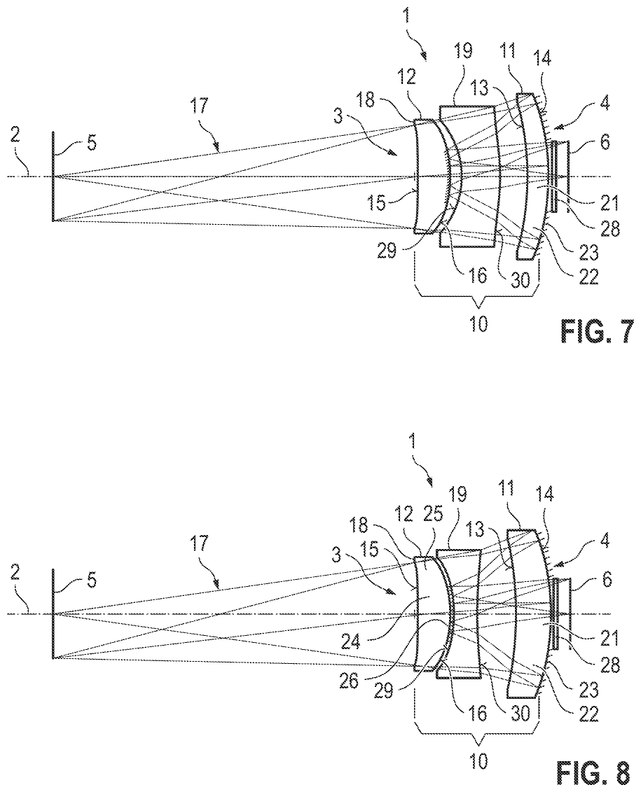

The exemplary embodiment shown in FIG. 7 shows an optical arrangement 1 in the form of a microscope objective which has the optical characteristics of the first exemplary embodiment. The reflective coating 26 of the second optical component 12 is arranged on the back side 16, which is to say the image-facing side, in this example. The reflective coating 26 has a convex configuration on the image side. It has a uniform shape which is continuously differentiable any desired number of times, which is to say it has a uniform polynomial surface description over the entire area of the back side 16 of the second optical component 12. In a manner analogous to the 3rd exemplary embodiment, a third optical component 19 in the form of a lens through which light passes three times in the beam path 17 is arranged geometrically, and in the beam path 17, between the first optical component 11 and the second optical component 12.

In contrast to the above-described exemplary embodiments, in which the front side 15 of the second optical component 12 was not continuously differentiable, the obscuration is 50% in this exemplary embodiment and in the two subsequent exemplary embodiments. The uniform, which is to say continuous and differentiable, surface design is advantageous for the manufacturing of the surfaces and reduces production costs. Moreover, it is advantageous in the context of centering the respective optical components and the precise positioning of the reflective partial regions.

The fifth exemplary embodiment shown in FIG. 8 differs from the fourth exemplary embodiment shown in FIG. 7 in that the front side 29 of the third optical component 19 rests against the back side 16 of the second optical component 12. Moreover, the second optical component 12 is configured as a lens which is passed once. A further structural difference is that the second reflection occurs not on the (convex) back side of the second optical component 12 but on the (concave) front side of the third optical component 19. Formally, the catadioptric arrangement is therefore formed by the first optical component 11 and the third optical component 19 in this exemplary embodiment.

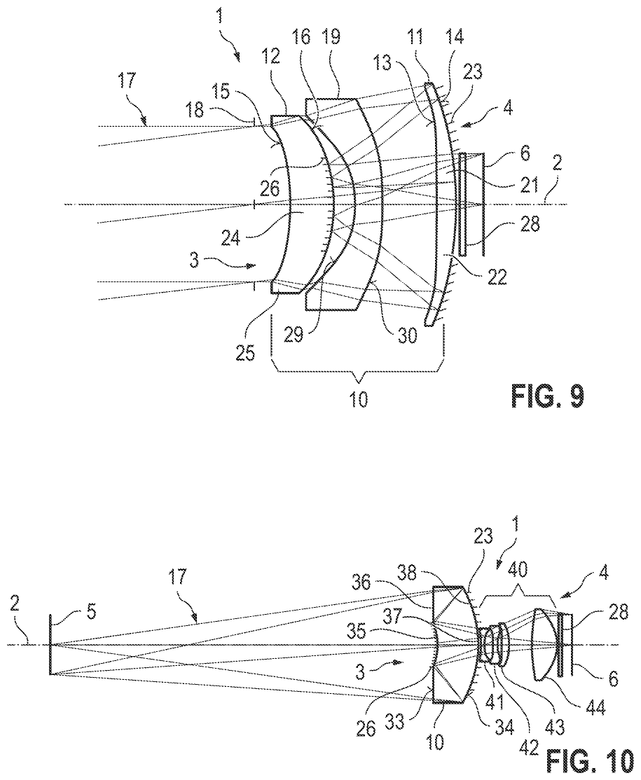

In the sixth exemplary embodiment shown in FIG. 9, the principle according to the disclosure is once again applied to an optical arrangement 1 which is configured as a photographic objective and which has a collimated beam input. The reflective coating 26 is once again arranged on the back side 16 of the second optical component 12. The third optical component 19 is configured as a lens through which light passes thrice.

A second embodiment variant of the present disclosure is explained in more detail hereinafter on the basis of the exemplary embodiments shown schematically in FIG. 10 to 13.

In the configuration shown in FIG. 10, the catadioptric arrangement 10 is configured as a single catadioptric component. The latter has a front side 33, arranged on the object side, and a back side 34, arranged on the image side. The front side 33 includes a radially inner region 35, which is configured to reflect light incident from the image side, and a radially outer region 36, which is designed to transmit. The back side 34 has a radially inner region 37, which is configured to transmit light incident from the object side, and a radially outer region 38, which is designed to reflect light incident from the object side. In this case, the reflective region of the front side 33 is shaped to be concave from the outside, which is to say convex in the beam path 17 or on the image side, and the reflective region of the back side 34 is shaped to be convex from the outside, which is to say concave in the beam path.

A field lens group 40 and optionally a plane parallel plate 28 are arranged geometrically or spatially, and in the beam path 17, between the back side 34 of the catadioptric arrangement or the catadioptric component 10 and the image plane 6, with the plane parallel plate 28 being arranged on the image side of the field lens group 40. The field lens group 40 includes a lens unit with negative refractive power, consisting of three refractive diverging lenses 40, 41 and 43 in the present case, and a lens unit with positive refractive power, including a refractive converging lens 44 in the present case.

As a rule, the front side 33 of the catadioptric arrangement 10 does not have a uniform surface shape. The reflective radially inner region 35 is usually described by a different surface equation to the radially outer, transmissive region 36. Typically, the two surface descriptions are at least configured such that they merge continuously into one another. Although this may apply to the back side 34, it need not necessarily apply there.

The basic course of the beam path 17, in particular within the catadioptric component 10, substantially corresponds to the beam path described in conjunction with the already-described exemplary embodiments. There would be a real intermediate image upon exit of the light from the radially inner region 37 of the back side 34 in the absence of the field lens group 40 behind the back side 34. The chief ray diverges away from the optical axis 2 upon exit of the light from the catadioptric component 10, which is to say the pupil of the air situated downstream the back side 34 is virtual and located upstream of the back side 34.

The field lens group 40 forms a pronounced retrofocus structure of negative and positive refractive power. The light leaves the catadioptric component or the catadioptric arrangement 10 with a convergent marginal ray angle, which is to say a real intermediate image would arise a short distance downstream of the catadioptric arrangement 10, as already mentioned. By contrast, the point of intersection of the chief ray with the optical axis 2 upon exit from the catadioptric arrangement 10 is located upstream thereof, which is to say the chief ray diverges. In order to obtain a convergent chief ray, it is necessary to use positive refractive power on the image side of the catadioptric arrangement 10, at a position where the chief ray height is larger than the size of the image. However, this is only the case at a certain distance downstream of the catadioptric arrangement 10, with the marginal rays having already focused at this point.

A strong diverging refractive power is used directly downstream of the catadioptric arrangement 10, which is to say on the image side, to shift the focus of the marginal rays of the catadioptric arrangement 10 further in the direction of the image plane 6 and let the chief ray height increase quicker in the light direction, the strong diverging refractive power specifically being in the form of a lens unit with negative refractive power, which includes the diverging lenses 41, 42, and 43, which moves the intermediate image significantly further away from the catadioptric arrangement 10, in order then to be able to set the desired convergent chief ray angle using the lens 44 with positive refractive power or a corresponding lens group.

In the exemplary embodiment shown, the lens unit with the diverging effect includes three doubly aspherical lenses 41, 42, and 43 and the lens unit with a converging effect includes a converging, doubly aspherical lens 44.

The imaging scale of the optical arrangement shown, which may be an objective, is −1:1. The angles of the chief ray in the object space and image space are the same in terms of absolute value and only differ in terms of sign.

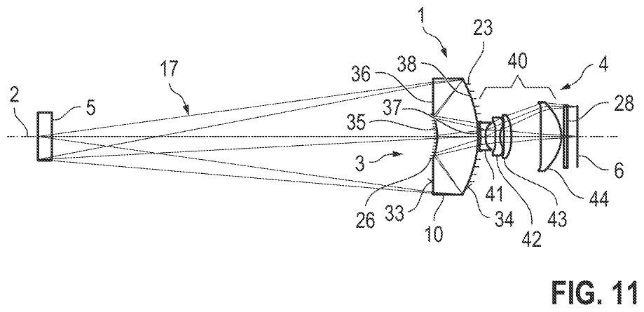

The exemplary embodiment shown in FIG. 11 differs from the exemplary embodiment shown in FIG. 10 in that the optical arrangement 1 in the form of an objective is designed for the observation of aqueous object spaces with an exemplary refractive index of n=1.334 (water). Accordingly, there is a magnifying imaging scale of −1.334:1. However, the geometric chief ray angles in the object and in the image are the same in terms of absolute value and differ in sign.

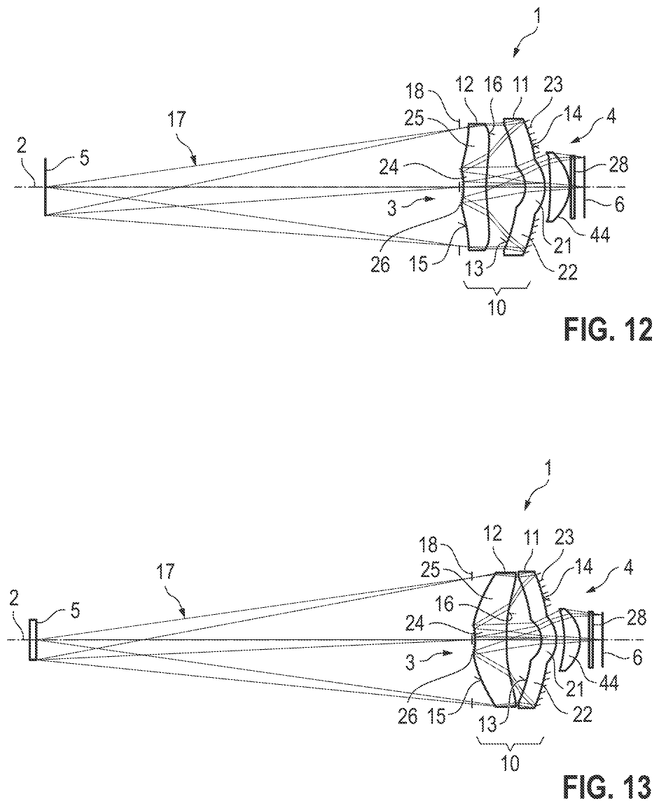

The exemplary embodiment shown in FIG. 12 builds on the exemplary embodiment shown in FIG. 10. However, in this case the catadioptric arrangement 10 includes a first optical component 11 and a second optical component 12, in a manner analogous to the exemplary embodiments of the first embodiment variant. This configuration is advantageous in that additional lens surfaces, in the form of the back side 16 of the second optical component 12 and the front side 13 of the first optical component 11, are available herewith as optical design means, in particular for beam shaping and for correcting aberrations.

Moreover, both the first optical component 11 and the second optical component 12 have at least one surface with a non-uniform surface description. By way of example, the radially outer region of the front side 15 of the second optical component 12 has a pronounced aspherical embodiment while the radially inner region of the front side 15 of the second optical component 12 has a pronounced concave embodiment when viewed from the outside. In the configuration shown, the back side 16 of the second optical component 12 is identified by a uniform surface description.

The first optical component 11 has a radially outer region 22 configured in slight meniscus form while the radially inner region 21 has a pronounced meniscus form, which is to say adopts the function of the divergently acting lens unit in comparison with the exemplary embodiment shown in FIG. 10. Outside of the catadioptric arrangement 10, the field lens group 40 merely consists of the converging lens 44 or a corresponding converging lens group in this example. This configuration has the advantage of enabling an overall very simple and compact arrangement which, in particular, requires only very few lens elements.

The exemplary embodiment shown in FIG. 13 differs from the above-described exemplary embodiment in that it is provided for an object space in or with aqueous solution, and consequently has an imaging scale of −1.334:1.

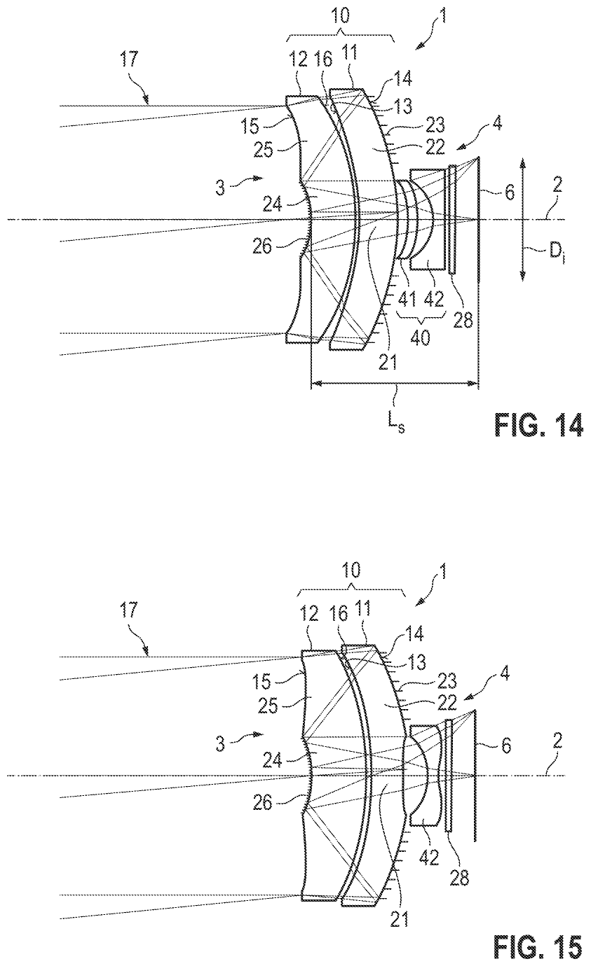

A third embodiment variant of the present disclosure is explained in more detail hereinafter on the basis of the exemplary embodiments shown schematically in FIG. 14 to 18. Here, the focus of the third embodiment variant is primarily that of effectively reducing the obscuration.

The optical arrangement 1 shown in FIG. 14 is embodied as a photographic objective, which is to say it serves to image objects situated at a distance. The shown photographic objective or the corresponding optical arrangement 1 has a focal length of 22 mm and is realized within an axial installation space of less than 6 mm. Hence, the telephoto factor is F=3,67. The axial installation space in this case indicates the distance from the front entrance surface, which is to say the front side 15 of the second optical component 12 in the present case, to the image plane 6. Two plane surfaces, between which the entire optical arrangement 1 can be accommodated, are considered for the distance. Thus, this does not only take into account the distance of the front surface vertex from the image plane, but the entire entrance surface.

Once again, the front side 15 of the second optical component 12 has no uniform surface description. Both the radially outer region 25 and the radially inner region 24 have an aspherical surface shape on the front side 15. However, the asphere equation for describing the radially outer region 25 of the front side 15 differs from the asphere equation for describing the radially inner region 24 of the front side 15. However, the surfaces are designed so that the two regions merge into one another, at least continuously but generally not in continuously differentiable fashion. This configuration is advantageous from a manufacturing point of view.

The surface description of the back side 14 of the first optical component 11 is not uniform either. The radially outer region 22, which is designed to be reflective, is convex when observed from the outside, which is to say the reflection from the inner side of the first optical component 11 occurs at a surface that is hollow or concave in the light direction. In the radially inner region 21, the back side 14 is predominantly shaped concavely. Both partial surface descriptions are aspherical and merge into one another continuously but not in continuously differentiable fashion.

In the beam path 17, the catadioptric arrangement 10 is adjoined by a lens group 40 which consists of a first diverging lens 41, for example consisting of polycarbonate, with substantially low refractive power and a second diverging lens 42 with high refractive power in this exemplary embodiment. In this case, it is especially the diverging lens 42 with high refractive power that acts as the field lens with negative refractive power required to reduce the obscuration. The obscuration is 40 percent in the present case. In this exemplary embodiment, the focal length of the optical arrangement 1 or objective has a value of f′=20 mm, which is to say an overall refractive power of φ=50 dpt. Furthermore, the field lens arrangement 40 has a vertex refractive power of 522 dpt.

The shown optical component parts and lenses typically consist predominantly of crown-type material, for example PMMA (PMMA—polymethyl methacrylate). The lens 41 is made of polycarbonate and has a doubly aspherical form. The use of a lens 41 with weak refractive power being made of the flint-type material polycarbonate moreover brings about a balanced chromatic correction of the overall design.

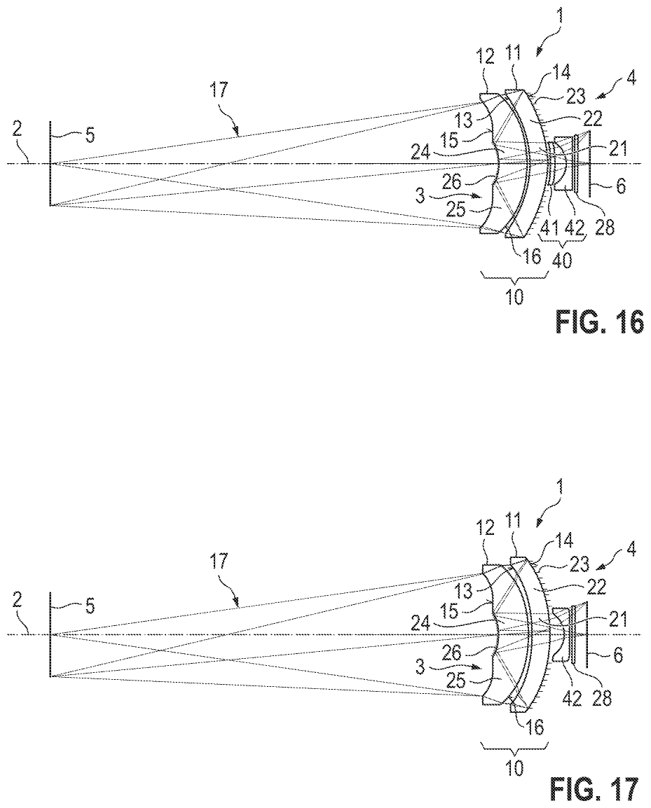

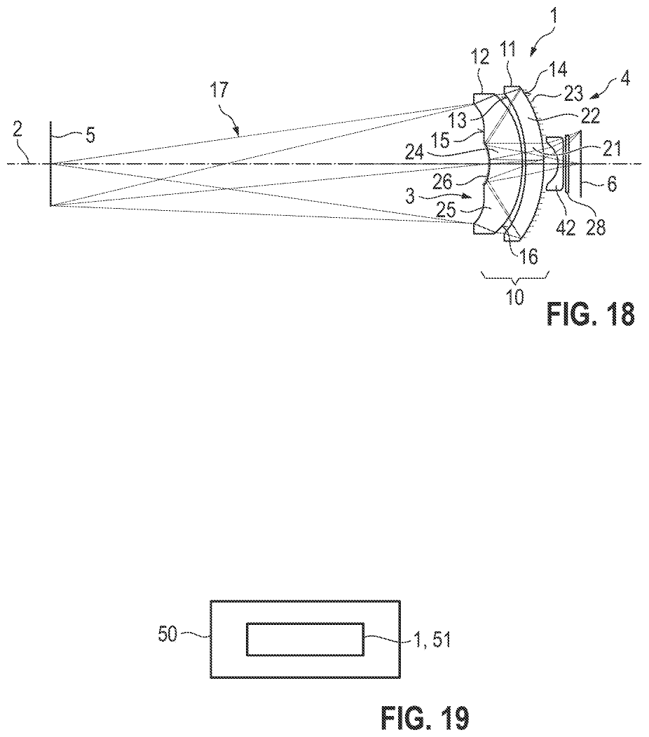

The diameter of the radially inner region 24 of the second optical component 12 has a slightly larger value than the inner region 21 of the first optical component 11. Both diameters are significantly smaller than the image diagonal, which is to say the diameter of the image plane 6. For quantification, it is possible to specify an (optically clear) diameter ratio between the region 24 and the diameter of the image diagonal, which ratio is at least smaller than 0.9, in particular smaller than 0.8 or 0.7. For example, this is not the case in FIGS. 4 to 9, where the diameter ratio is ˜1. The diameter ratio is 0.61 for the example shown in FIG. 14, 0.58 for the example shown in FIG. 15, 0.63 for the example shown in FIG. 16, 0.60 for the example shown in FIG. 17, and 0.62 for the example shown in FIG. 18. This once again reflects the fact that the diverging field lenses 41 or 42 or the field lens arrangement 40 lead/leads to a significant beam curtailment and consequently allows a minimal obscuration.

What is further advantageous for a small obscuration is that the radially outer region 22 of the first optical component 11, which is to say the reflective region, has a diameter that is as large as possible so that the diameter ratio between the radially outer, reflective region 22 and the radially inner, non-reflective region 20 becomes maximal, which in turn has an advantageous effect on the obscuration, which is to say reduces the latter. The reduction in the obscuration is achieved, inter alia, by the fact that the first optical surface on which the light is incident, which is to say the front side 15 of the second optical component 12, has a concave and hence diverging shape in the edge region. In particular, this increases the diameter of the beam at the location of the first optical component 11 and thus facilitates the realization of a small obscuration.

In contrast to the exemplary embodiment shown in FIG. 14, the first field lens 41 has been removed in the exemplary embodiment shown in FIG. 15. In the present case, the effect of the lens 41 was replaced by the first optical component 11 being made of polycarbonate and by the radially inner region 21 having a different surface description to the radially outer partial region 22, as a result of which the back side 14 no longer has a uniform surface description. However, the surface descriptions of the radially inner region and radially outer region on the back side 14 merge into one another continuously, albeit not in continuously differentiable fashion. Otherwise, the exemplary embodiment shown in FIG. 15 corresponds to the exemplary embodiment shown in FIG. 14.

The exemplary embodiments shown in FIGS. 14 and 15 relate to optical units with an infinite front focal length, as are typically used in the field of photographic optics in cellular telephones. The exemplary embodiments shown in FIGS. 16 to 18 relate to projection objectives which are based on the same principle, specifically of realizing a catadioptric arrangement with the smallest possible obscuration. In this case, the imaging scale is close to |β|=1:1, in order to enable microscopic applications. In this case, a large working distance free working distance (FWD) should be obtained during 1:1 imaging despite a very compact structure. Here, this free working distance should be twice as large as the quotient of installation length Ls or overall length or installation space L and the imaging scale β:

$$F W D > 2 \frac{Ls}{β} or optionally F W D > 2 \frac{L}{β}$$

Here, Lₛ denotes the installation length, which is to say the distance of the first lens vertex from the image plane. L denotes the overall length or the installation space, which is to say the spacing of two planes between which the entire optical unit can be “inserted”, which is to say the distance from the lens edge to the image plane, as measured parallel to the optical axis, in the present case.

In the case of the microscope objectives shown, the imaging scale is −0.8:1 and the overall length or the installation space L is approximately 6.5 mm, which is to say the working distance should be at least 15 mm.

In the exemplary embodiments shown in FIGS. 16 to 18, the working distance of the object is 25 mm in each case. The aforementioned condition for the working distance FWD is satisfied very well with the aforementioned imaging scale of −0.8:1 and an installation space L of 6.5 mm. Otherwise, the individual optical components and lenses as well as materials thereof and the sequence of surfaces of the exemplary embodiment shown in FIG. 16 correspond to those of the exemplary embodiment shown in FIG. 15. In contrast to the exemplary embodiment shown in FIG. 15, the obscuration is only 36 percent.

FIG. 17 shows an optical arrangement in the form of a microscope objective with an imaging scale of −0.8:1. The general structure is identical to that of the exemplary embodiment shown in FIG. 15. Here, too, the first of the two field lenses, which is to say the lens 41, was dispensed with and use was made instead of a first optical component 11 made of a flint material, for example polycarbonate, and the back side 14 of the first optical component 11 was designed as a non-uniformly defined surface such that the optical effect in the transmissive radially inner region 21 differs from the optical effect in the reflective radially outer region 22. Here, too, the two partial surface regions merge into one another continuously, but not in differentiable fashion. Once again, the obscuration is 36 percent.

In the exemplary embodiment shown in FIG. 18, the design degree of freedom of a non-uniformly defined back side 14 of the first optical component 11 was dispensed with, with the result that the optical arrangement 1 is now constructed from the catadioptric arrangement 10 with a non-uniformly defined front side 15, a uniformly defined back side 14 and a field lens 42 with negative refractive power. The obscuration is 38 percent in this case.

The features of the exemplary embodiments of the third embodiment variant advantageous for a low obscuration are compiled in the following tables. Here, Lₛ denotes the installation length, which is to say the distance of the first lens vertex from the image plane. L denotes the overall length or the installation space, which is to say the spacing of two planes between which the entire optical unit can be “inserted”, which is to say the distance from the lens edge to the image plane, as measured parallel to the optical axis, in the present case. D₂ is the optically clear diameter of the transmissive region on the back side of the first optical component 11. D₁ is the diameter of the detector or its image diagonal or the diameter of the surface of the image plane in which an image representation is generated, or the diameter of the exit pupil. F_{FL}′ is the paraxial refractive power of the field lens group with negative refractive power, and RH₁ and RH₂ are the best fit radii of the field lens with negative refractive power. F_{FLH}′ is the best fit radius refractive power of the field lens with negative refractive power. N₂*RVL₂ is the meridional optical direction cosine of the chief ray prior to the exit from the first optical component 11. Nᵢ*RVLᵢ is the optical direction cosine of the chief ray at the detector or at the image plane 6. Here, the optical direction cosine is understood to be the geometric direction cosine multiplied by the refractive index of the respectively considered medium.

TABLE 1

| FIG. | L_{S} | L | F_{FL}′ | \|L_{S}/F_{FL}′\| | \|L/F_{FL}′\| |
|---|---|---|---|---|---|
| 14 | 5.505 | 5.962 | −1.914 | 2.876 | 3.115 |
| 15 | 5.195 | 5.205 | −2.104 | 2.469 | 2.474 |
| 16 | 5.751 | 6.500 | −1.956 | 2.940 | 3.323 |
| 17 | 5.559 | 6.155 | −1.838 | 3.024 | 3.349 |
| 18 | 5.796 | 6.501 | −1.884 | 3.076 | 3.451 |

| FIG. | D₂ | Dᵢ | D₂/Dᵢ |
|---|---|---|---|
| 14 | 2.327 | 3.840 | 0.606 |
| 15 | 2.267 | 3.840 | 0.590 |
| 16 | 2.374 | 3.840 | 0.618 |
| 17 | 2.343 | 3.840 | 0.610 |
| 18 | 2.444 | 3.840 | 0.637 |

TABLE 3

| FIG. | RH₁ | RH₂ | F_{FLH}′ |
|---|---|---|---|
| 14 | −1.361 | −101.469 | −2.805 |
| 15 | −1.596 | −20.052 | −3.526 |
| 16 | −1.383 | −55.220 | −2.884 |
| 17 | −1.356 | −12.076 | −3.106 |
| 18 | −1.444 | 13.622 | −2.654 |

TABLE 4

| FIG. | N₂*RVL₂ | Nᵢ*RVLᵢ | Nᵢ*RVLᵢ/N₂*RVL₂ |
|---|---|---|---|
| 14 | 0.299 | 0.531 | 1.774 |
| 15 | 0.324 | 0.535 | 1.646 |
| 16 | 0.302 | 0.522 | 1.725 |
| 17 | 0.307 | 0.532 | 1.731 |
| 18 | 0.286 | 0.572 | 2.004 |

FIG. 19 schematically shows a device 50 according to the disclosure. The device 50 can be a microscope or a mobile device. The device 50 includes an above-described optical arrangement 1 according to the disclosure. It has the features and advantages already mentioned in this context. In particular, the optical arrangement 1 can be configured as an objective 51 and/or can contain an image capture apparatus, for example a camera.

It is understood that the foregoing description is that of the exemplary embodiments of the disclosure and that various changes and modifications may be made thereto without departing from the spirit and scope of the disclosure as defined in the appended claims.

### LIST OF REFERENCE NUMERALS

1 Optical arrangement
2 Center axis
3 Object side
4 Image side
5 Object/object plane
6 Image plane/detector
7 First converging lens
8 Second converging lens
9 Chief ray
10 Catadioptric arrangement
11 First, partly reflective optical component
12 Second, partly reflective optical component
13 Front side
14 Back side
15 Front side
16 Back side
17 Beam path
18 Entrance pupil/stop
19 Third optical component
21 Radially inner region
22 Radially outer region
23 Reflective coating
24 Radially inner region
25 Radially outer region
26 Reflective coating
27 Diverging lens
28 Plane parallel plate
29 Front side
30 Back side
31 First reflective optical surface, primary mirror
32 Second reflective optical surface, secondary mirror
33 Front side
34 Back side
35 Radially inner region
36 Radially outer region
37 Radially inner region
38 Radially outer region
40 Field lens group
41 Lens with negative refractive power, diverging lens
42 Lens with negative refractive power, diverging lens
43 Lens with negative refractive power, diverging lens
44 Lens with positive refractive power, converging lens
50 Device
51 Objective
Ai Object
Aᵢ′ Image representation
Dᵢ Diameter of the exit pupil, diameter of the detector or its image diagonal
d₀ Beam diameter
d₁ Diameter of the entrance pupil
d₂ Diameter of the entrance pupil
Lₛ Distance from the vertex of the object side to the image plane
L₀ Distance from the entrance pupil to the image plane or to the detector
h₀ Height of the marginal ray R0
h₁ Height of the light ray R1
R₀ Marginal ray
R₁ Light ray
rvlₒ Direction cosine of the marginal ray R0
rvl₁ Direction cosine of the light ray R1
γ Chief ray angle
γ′ Chief ray angle

What is claimed is:

1. An optical arrangement, comprising:
a center axis;
an object side;
an image side; and
a catadioptric arrangement,
wherein the optical arrangement has an installation space of no more than 25 millimeters from the object side to the image side along the center axis, and a linear obscuration of no more than 60 percent.

2. The optical arrangement as claimed in claim 1, wherein the catadioptric arrangement comprises a first, partly reflective optical component with a front side arranged on the object side and a back side arranged on the image side, and a second, partly reflective optical component with a front side arranged on the object side and a back side arranged on the image side, the optical components being arranged in succession in the beam path along the center axis such that the first optical component is arranged on the image side of the second optical component,
wherein the first optical component comprises a radially inner region and a radially outer region in relation to the center axis, the inner region being configured to at least partly transmit light incident from the object side and the back side of the outer region being configured to reflect light incident from the object side,
wherein the second optical component comprises a radially inner region and a radially outer region in relation to the center axis, the outer region being configured to transmit light incident from the object side and the inner region being configured to reflect light incident from the image side, and
wherein at least one first refractive surface with refractive power and one second refractive surface with refractive power are arranged in the beam path between the back side of the first optical component and the front side of the second optical component.

3. The optical arrangement as claimed in claim 2, wherein at least one of:
the first refractive surface with refractive power is formed by the front side of the first optical component, and
the second refractive surface with refractive power is formed by the back side of the second optical component.

4. The optical arrangement as claimed in claim 2, wherein the first optical component is configured such that only the front side and/or the back side have refractive power and the image plane is arranged immediately on the image side of the first optical component.

5. The optical arrangement as claimed in claim 2, wherein at least one third optical component is arranged geometrically, and in the beam path, between the first optical component and the second optical component.

6. The optical arrangement as claimed in claim 5, wherein the at least one third optical component is configured to be refractive and/or the at least one third optical component is configured to correct at least one imaging aberration.

7. The optical arrangement as claimed in claim 2, wherein the radial extents of individual optical components of the optical arrangement deviate from one another by no more than 2 millimeters or no more than 30 percent.

8. The optical arrangement as claimed in claim 2, wherein the outer region and the inner region on the back side of the first optical component have different surface shapes from one another and/or the outer region and the inner region on the front side and/or on the back side of the second optical component have different surface shapes from one another.

9. The optical arrangement as claimed in claim 1, wherein at least one field lens is arranged in the beam path and/or geometrically between the catadioptric arrangement and the image side.

10. The optical arrangement as claimed in claim 9, wherein at least one field lens group comprising at least one lens with positive refractive power and/or at least one lens with negative refractive power is arranged in the beam path and/or geometrically between the catadioptric arrangement and the image side of the optical arrangement.

11. The optical arrangement as claimed in claim 9, wherein the field lens group comprises a first lens or lens group with positive refractive power and a second lens or lens group with negative refractive power arranged upstream of the first lens or lens group in the beam path.

12. The optical arrangement as claimed in claim 9, wherein the catadioptric arrangement comprises a front side arranged on the object side, a back side arranged on the image side and, in relation to the center axis, a radially inner region and a radially outer region, with the inner region on the back side being configured to at least partly transmit light incident on the object side and having negative refractive power.

13. The optical arrangement as claimed in claim 9, wherein the catadioptric arrangement comprises a first, partly reflective optical component with a front side arranged on the object side and a back side arranged on the image side, and a second, partly reflective optical component with a front side arranged on the object side and a back side arranged on the image side, the optical components being arranged in succession in the beam path along the center axis such that the first optical component is arranged on the image side of the second optical component,
wherein the first optical component comprises a radially inner region and a radially outer region in relation to the center axis, the inner region being configured to at least partly transmit light incident from the object side and the back side of the outer region being configured to reflect light incident from the object side, and
wherein the second optical component comprises a radially inner region and a radially outer region in relation to the center axis, the outer region being configured to transmit light incident from the object side and the inner region being configured to reflect light incident from the image side.

14. The optical arrangement as claimed in claim 13, wherein the radially inner region of the first optical component has negative refractive power.

15. The optical arrangement as claimed in claim 1, wherein a field lens group is arranged on the image side of the catadioptric arrangement and the optical arrangement defines an image plane,
wherein the optical arrangement has an installation length Lₛ measured from the vertex of the first optical surface to the image plane and the field lens group has a paraxial focal length f′FL less than zero (f′_{FL}<0), and
wherein the absolute value of the paraxial focal length f′_{FL} is less than the focal length Lₛ (|f′_{FL}|<Lₛ).

16. The optical arrangement as claimed in claim 1, wherein at least one field lens is arranged on the image side of the catadioptric arrangement and the optical arrangement defines an image plane with an imaging surface with a diameter D₁, with the optical arrangement having an image-side clear optical diameter D₂ from the back side of the catadioptric arrangement, with the ratio of the clear optical diameter D₂ to the diameter D₁ of the imaging surface being less than 1.

17. The optical arrangement as claimed in claim 1, wherein at least one field lens is arranged on the image side of the catadioptric arrangement and the optical arrangement defines an image plane,
wherein the optical arrangement has a focal length f′ and an installation length Lₛ as measured from the vertex of the first optical surface to the image plane, and
wherein the ratio of the focal length f′ to the installation length Lₛ is larger than 2.

18. The optical arrangement as claimed in claim 1, wherein at least one field lens is arranged on the image side of the catadioptric arrangement and the optical arrangement defines an image plane,
wherein the optical arrangement has an imaging scale β, a distance FWD of an object plane from the vertex of the first optical surface and an installation length Ls as measured from the vertex of the first optical surface to the image plane, and
wherein the product of the imaging scale β and the quotient of the distance FWD and the installation length Lₛ is larger than 2.

19. The optical arrangement as claimed in claim 1, wherein the chief ray angle of the beam path immediately prior to leaving the catadioptric arrangement at the backside thereof, where the catadioptric arrangement has a refractive index n₂, has a direction cosine rvl₂, and
wherein the chief ray angle of the beam path in an image plane in an image-side medium with a refractive index n₁ (at the detector) has a direction cosine rvl₁, with the following applying: (n₂*rvl₂)/(n₁*rvl₁)<1.

20. The optical arrangement as claimed in claim 1, wherein the optical arrangement has at least one of a negative imaging scale, a positive entrance pupil position, and a positive exit pupil position.

21. The optical arrangement as claimed in claim 1, wherein the beam path has an even number of reflections.

22. The optical arrangement as claimed in claim 1, wherein the optical arrangement has an aperture stop and the distance between an object plane defined by the optical arrangement and the aperture stop is larger than the distance between the aperture stop and an image plane defined by the optical arrangement.

23. The optical arrangement as claimed in claim 1, wherein at least one of the optical surfaces in the beam path is configured to be continuous and at least one time continuously differentiable.

24. The optical arrangement as claimed in claim 1, wherein the optical arrangement has a linear obscuration of no more than 50 percent.

25. The optical arrangement as claimed in claim 1, wherein the optical arrangement is at least one of configured as a microscope, and designed for a mobile device.

26. An objective comprising an optical arrangement as claimed in claim 1.

27. An image capture apparatus or image reproduction apparatus comprising an objective as claimed in claim 26.

28. A device, comprising:
an image capture apparatus;
an image reproduction apparatus; or
an optical arrangement as claimed in claim 1.
